(19) United States
(12) Patent Application Publication
(10) Pub. No.: US 2019/0080103 A1
(43) Pub. Date: Mar. 14, 2019

(54) POLICY-BASED AUTOMATION AND SINGLE-CLICK STREAMLINING OF AUTHORIZATION WORKFLOWS

(71) Applicant: Carrier Corporation, Palm Beach Gardens, FL (US)

(72) Inventors: Tarik Hadzic, Cork (IE); Keith J. Power, Cork (IE); Stylianos Basagiannis, Cork (IE); Menouer Boubekeur, Cork (IE); Blanca Florentino, Cork (IE); Vijaya Ramaraju Lakamraju, Avon, CT (US); Philip J. Harris, Cork (IE); Ankit Tiwari, Framingham, MA (US)

(21) Appl. No.: 16/078,512

(22) PCT Filed: Feb. 7, 2017
(86) PCT No.: PCT/US2017/016838

§ 371 Date: Aug. 21, 2018

Related U.S. Application Data
(60) Provisional application No. 62/298,752, filed on Feb. 23, 2016.

(51) Int. Cl. G06F 21/62; H04L 29/06; G06F 21/60

(52) U.S. Cl. CPC G06F 21/62; H04L 63/10; G06F 2221/2141; G06F 21/604; H04L 63/205

(57) ABSTRACT

A method for controlling authorization decisions for resource access is provided. The method includes generating a request signal that includes resource identification information, transmitting the request signal for resource access to an authorization system, receiving the request signal at the authorization system, and generating an authorization request signal based on the request signal. The authorization request signal requires a single Boolean data type response in the form of either a grant access reply and a deny access reply. The method also includes transmitting the authorization request signal to a resource access manager, selecting and transmitting, using the resource access manager, the single Boolean data type response in the form of either the grant access reply and the deny access reply, receiving the Boolean data type response at the authorization system, generating an authorization signal based on the Boolean data type response, and transmitting the authorization signal from the authorization system.

### BACKGROUND

The subject matter disclosed herein generally relates to authorization automation and, more particularly, to policy-based automation and single-click streamlining of authorization workflows.

Electronic authorization workflows are deployed in large organizations to manage the process of providing permissions for subjects to access resources, such as permissions to install software, obtain access rights to a folder, rights to enter physical areas, etc. In a typical scenario as shown in FIG. 1 (Scenario 1), a subject requests an access right to a resource via an electronic form (e.g. over web form); an administrator of the authorization system requests a decision from a corresponding resource owner; the owner makes an approve/deny decision and informs the administrator who implements the decision in the system. This approach proves to be cumbersome and time consuming for all parties. Further, even in more streamlined scenarios there still exists a constant cumbersome need for parties to participate actively in a multiple step process. For example in another scenario as shown in FIG. 1 (Scenario 2), the resource owner can log on the system directly and approve/deny requests pertaining to resources under his responsibility.

Specifically, FIG. 1 illustrates conventional authorization workflows for implementing authorization control and resource access. The scenarios include a user 110, an authorization system 120, a system administrator 130, and a resource owner 140 that are communicatively connected to each other. Scenario 1 includes a request to access rights to a resource (operation 1.05) from the user 110 to the authorization system 120 which informs the administrator 130 of the request (operation 1.10). The system administrator 130 identifies and informs the resource owner 140 (operations 1.15). The resource owner 140 then makes an authorization decision and informs the administrator 130 of the decision (operation 1.20). The administrator 130 implements the decision on the system 120 (operation 1.25) which then informs the user 110 about the decision outcome (operation 1.30).

In scenario 2 the user 110 sends a request to access rights to a resource to the authorization system 120 (operation 1.35) which directly informs the resource owner 140 (operation 1.40). The resource owner 140 then logs into the system 120 (operation 1.45) and then makes an authorization decision and implements the decision on the system 120 (operation 1.50). The authorization system 120 then informs the user 110 of the decision outcome (operation 1.55).

In both cases there are large amounts of administrative effort required along with long waiting times for the access requests to be resolved. Further, both scenarios include the possibility of error in judgment when making authorization decision without any form of check or control. Further, the scenarios can include inconsistency in decision making based on ad-hoc judgment of resource owners.

Accordingly, there exist a need to provide a better way of handling resource request authentication and authorization.

### BRIEF DESCRIPTION

According to one embodiment a method for controlling authorization decisions for resource access is provided. The method includes generating, using a processor of a user device, a request signal that includes resource identification information based on a user input, transmitting, from the user device, the request signal for resource access to an authorization system, receiving the request signal at the authorization system, generating an authorization request signal based on the request signal, wherein the authorization request signal requires a single Boolean data type response in the form of either a grant access reply and a deny access reply, transmitting the authorization request signal to a resource access manager, selecting and transmitting, using the resource access manager, the single Boolean data type response in the form of either the grant access reply and the deny access reply, receiving the Boolean data type response at the authorization system, generating an authorization signal based on the Boolean data type response, and transmitting the authorization signal from the authorization system to at least one from a group consisting of the user device and another user device.

In addition to one or more of the features described above, or as an alternative, further embodiments of the method may include, wherein the resource access manager includes a policy engine that applies authorization logic and authorization policies to automatically process the authorization request signal without explicit manual involvement and generates the Boolean data type response based on the automatically processed authorization request signal.

In addition to one or more of the features described above, or as an alternative, further embodiments of the method may include, wherein the resource access manager further includes a resource owner that specifies the authorization policies which are then repeatedly used by the policy engine to make decisions.

In addition to one or more of the features described above, or as an alternative, further embodiments of the method may include, wherein the authorization policies include one or more of a grant access policy, a grant access and report policy, a report and recommend policy, and a report policy.

In addition to one or more of the features described above, or as an alternative, further embodiments of the method may include, overriding, by the resource owner, the automatic processing by the policy engine of the authorization request signal by selecting the Boolean data type response, and calculating, using the policy engine, whether the Boolean data type response selected by the resource owner is in compliance with the authorization policies in response to the resource owner overriding.

In addition to one or more of the features described above, or as an alternative, further embodiments of the method may include, wherein the resource access manager includes a resource owner that generated the single Boolean data type response using a 1-click authorization response utilizing one or more communication channels and one or more message communication schemes.

In addition to one or more of the features described above, or as an alternative, further embodiments of the method may include, wherein the authorization request signal includes a grant link that when selected by the resource owner returns the grant access reply as the Boolean data type response to the authorization system, and a deny link that when selected by the resource owner returns the deny access reply as the Boolean data type response to the authorization system.

In addition to one or more of the features described above, or as an alternative, further embodiments of the method may include, wherein the message communication schemes include email, instant messaging, texting, and a web-based graphical user interface (GUI).

In addition to one or more of the features described above, or as an alternative, further embodiments of the method may include, wherein the one or more communication channels include a Personal area network (PAN), Local area network (LAN), Metropolitan area network (MAN), Wide area network (WAN), Storage area network (SAN), Enterprise private network (EPN), and Virtual private network (VPN) implemented over a wireless connection, a wired connection, or a combined wired and wireless connection.

According to one embodiment a system for controlling authorization decisions for resource access is provided. The system includes a user device that generates, using a processor, a request signal that includes resource identification information based on a user input, and transmits the request signal for resource access, an authorization system that receives the request signal and generates an authorization request signal based on the request signal, wherein the authorization request signal requires a single Boolean data type response in the form of either a grant access reply and a deny access reply, and wherein the authorization system transmits the authorization request signal, and a resource access manager that selects and transmits the single Boolean data type response in the form of either the grant access reply and the deny access reply, wherein the authorization system receives the Boolean data type from the resource access manager, generates an authorization signal based on the Boolean data type response, and transmits the authorization signal from the authorization system to at least one from a group consisting of the user device and another user device.

In addition to one or more of the features described above, or as an alternative, further embodiments of the system may include, wherein the resource access manager includes a policy engine that applies authorization logic and authorization policies to automatically process the authorization request signal without explicit manual involvement and generates the Boolean data type response based on the automatically processed authorization request signal.

In addition to one or more of the features described above, or as an alternative, further embodiments of the system may include, wherein the resource access manager further includes a resource owner that specifies the authorization policies which are then repeatedly used by the policy engine to make decisions.

In addition to one or more of the features described above, or as an alternative, further embodiments of the system may include, wherein the authorization policies include one or more of a grant access policy, a grant access and report policy, a report and recommend policy, and a report policy.

In addition to one or more of the features described above, or as an alternative, further embodiments of the system may include wherein the resource owner overrides the automatic processing by the policy engine of the authorization request signal by selecting the Boolean data type response, and wherein the policy engine calculates whether the Boolean data type response selected by the resource owner is in compliance with the authorization policies in response to the resource owner overriding.

In addition to one or more of the features described above, or as an alternative, further embodiments of the system may include, wherein the resource access manager includes a resource owner that generated the single Boolean data type response using a 1-click authorization response utilizing one or more communication channels and one or more message communication schemes.

In addition to one or more of the features described above, or as an alternative, further embodiments of the system may include, wherein the authorization request signal includes a grant link that when selected by the resource owner returns the grant access reply as the Boolean data type response to the authorization system, and a deny link that when selected by the resource owner returns the deny access reply as the Boolean data type response to the authorization system.

In addition to one or more of the features described above, or as an alternative, further embodiments of the system may include, wherein the message communication schemes include email, instant messaging, texting, and a web-based graphical user interface (GUI).

In addition to one or more of the features described above, or as an alternative, further embodiments of the system may include, wherein the one or more communication channels include a Personal area network (PAN), Local area network (LAN), Metropolitan area network (MAN), Wide area network (WAN), Storage area network (SAN), Enterprise private network (EPN), and Virtual private network (VPN) implemented over a wireless connection, a wired connection, or a combined wired and wireless connection.

According to one embodiment, a computer program product for controlling authorization decisions for resource access is provided. The computer program product including a computer readable storage medium having program instructions embodied therewith, the program instructions executable by one or more processors to cause the processors to generate, using a user device, a request signal that includes resource identification information based on a user input, transmit, from the user device, the request signal for resource access to an authorization system, receive the request signal at the authorization system, generate an authorization request signal based on the request signal, wherein the authorization request signal requires a single Boolean data type response in the form of either a grant access reply and a deny access reply, and transmit the authorization request signal to a resource access manager, select and transmit, using the resource access manager, the single Boolean data type response in the form of either the grant access reply and the deny access reply, receive the Boolean data type response at the authorization system, generate an authorization signal based on the Boolean data type response, and transmit the authorization signal from the authorization system to at least one from a group consisting of the user device and another user device.

In addition to one or more of the features described above, or as an alternative, further embodiments of the computer program product may include a policy engine that applies authorization logic and authorization policies to automatically process the authorization request signal without explicit manual involvement and generates the Boolean data type response based on the automatically processed authorization request signal, and a resource owner that specifies the authorization policies which are then repeatedly used by the policy engine to make decisions.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the present disclosure are apparent from the following detailed description taken in conjunction with the accompanying drawings in which:

FIG. 1 illustrates conventional authorization workflows for implementing authorization control and resource access;

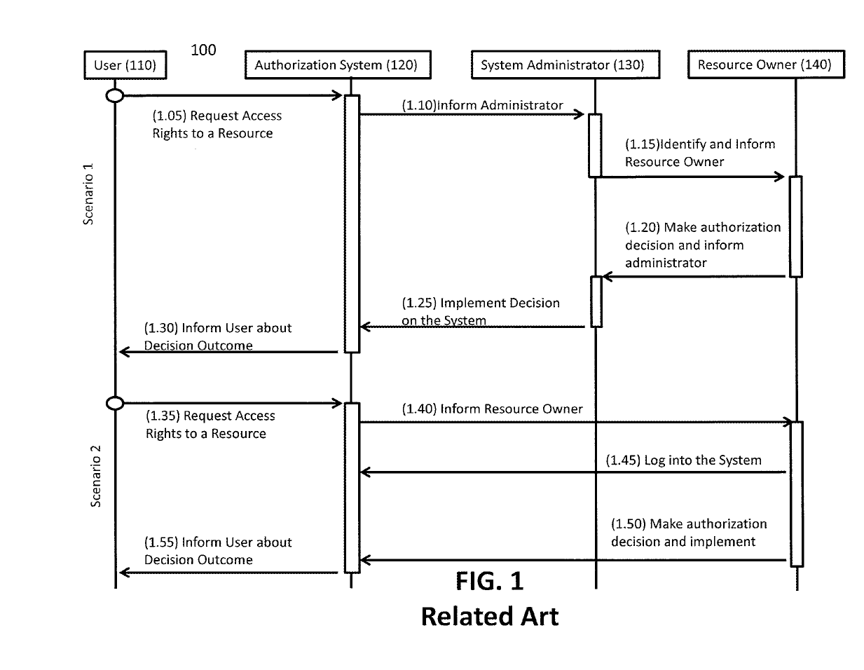

FIG. 2 illustrates a single-click workflow for implementing authorization control and resource access in accordance with one or more exemplary embodiments;

FIG. 3 illustrates an automated authorization workflow using a policy engine for implementing authorization control and resource access in accordance with one or more exemplary embodiments;

FIG. 4 illustrates a compliance flowchart for checking authorization and resource access decisions with a policy in accordance with one or more exemplary embodiments; and

FIG. 5 illustrates a method for controlling authorization decisions for resource access in accordance with one or more exemplary embodiments.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

One or more embodiments described herein are directed to a method and/or system for authorizing a user that is attempting to secure resource access such as, for example, access to different buildings or room at work, access to protected data, tools, or other resources, access to open a door or call an elevator call in a building, etc. The system includes a user, an authorization system, a policy engine, a system administrator, and a resource owner. This method and system could provide improved authorization response time and accuracy as well as improved protection through compliance tracking and applied system validation from analysis of collected usage information overtime. The system and method could also provide an improved user experience and reduce implementation overhead of both time and processing resources. For example, according to one or more embodiments, a single-click authorization method and/or an authorization method controlled by a policy engine can be provided.

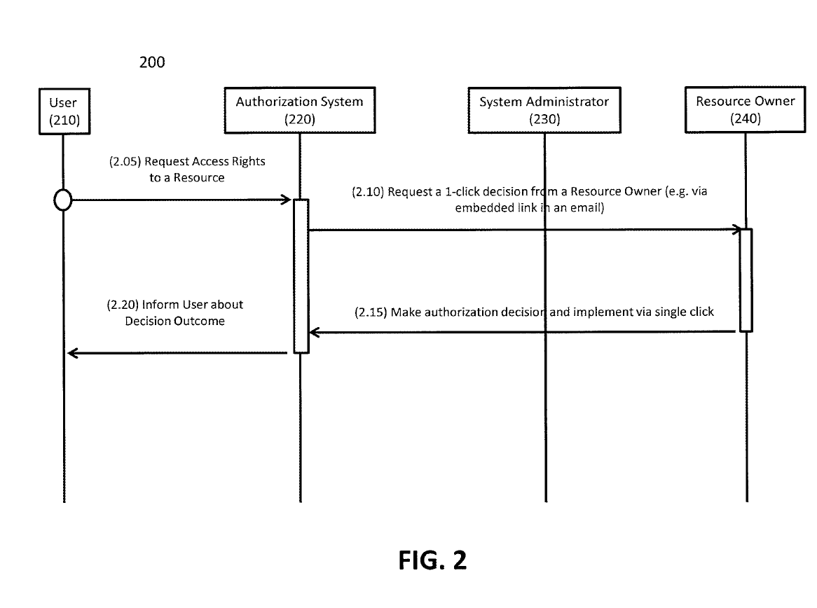

For example, turning now to FIG. 2, the figure illustrates a single-click workflow for implementing authorization control and resource access in accordance with one or more exemplary embodiments.

Specifically, according to one or more embodiments, the method 200 includes a user 210 which sends a request to access rights to a resource to an authorization system 220 (operation 2.05). The authorization system 220 then sends a request for a 1-click decision from a resource owner 240 (operation 2.10) bypassing the system administrator 230 entirely. According to one embodiment, the system administrator 230 may help route the request signals without providing any substantive processing or data handling. The resource owner 240 makes an authorization decision and implements the decision on the authorization system 220 via a single click of an embedded link included in the email, text, chat, or other form of digital communication (operation 2.15). The authorization system 220 then informs the user 210 about the decision outcome (operations 2.20).

Therefore, according to one or more embodiments, the method 200 is able to minimize the effort that a resource owner 240 has to invest into making a decision for each request and to minimize the number of applications that the resource owner 240 has to learn to use. According to one or more exemplary embodiments, the process uses external software components already familiar to the resource owner 240, such as email clients, in order to elicit decisions (e.g. using an embedded link within an email). According to one or more exemplary embodiments, authentication of the resource owner 240 is based on the authentication mechanism deployed by the external component (e.g. email authentication).

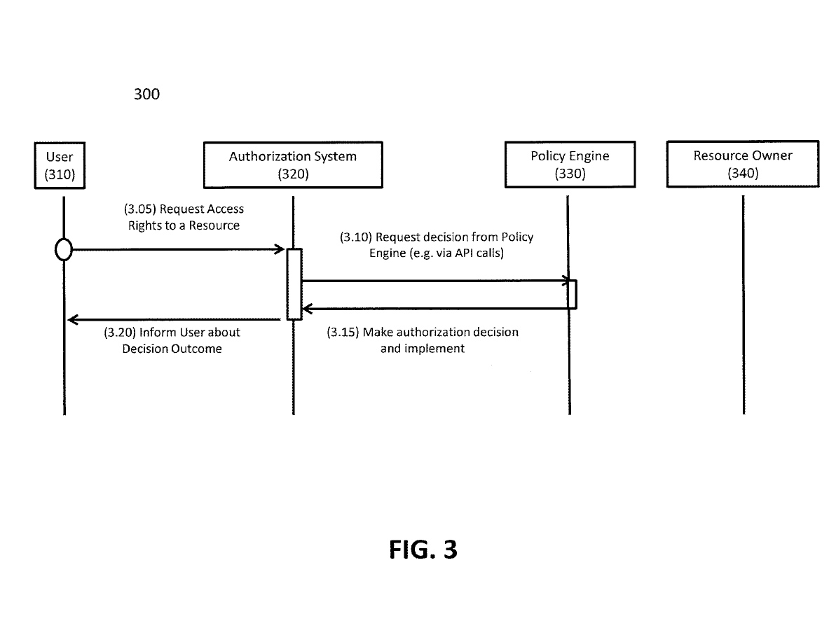

FIG. 3 illustrates a system and an automated authorization workflow using a policy engine 330 for implementing authorization control and resource access in accordance with one or more exemplary embodiments.

Specifically, according to one or more embodiments, a user 310 sends a request for access rights to a resource to the authorization system 320 (operation 3.05). The authorization system 320, in turn, requests a decision from a policy engine 330 (operation 3.10). The authorization system 320 may implement this request using API calls. The policy engine 330 then makes an authorization decision and implements the decision in the authorization system 320 (operation 3.15). The authorization system 320 then informs the user 310 about the decision outcome (operations 3.20).

Further, in accordance with one or more embodiments, some authorization requests are automatically processed by the policy engine 330 if they meet applicability criteria. For example, requests to access highly sensitive areas cannot be processed automatically but high-frequency requests to standard resources might be applicable.

According to another embodiment, the authorization policies are constructed in a distributed manner, by combining local policies specified by resource owner 340 with policies specified by other relevant stakeholders (such as access control administrators, etc.) into a global policy. The resource owner 340 responsible for approving/denying access to specific set of resources specifies a local authorization policy which expresses criteria by which the authorizer normally decides whether a request to resources under his control can be approved. According to another embodiment, the local authorization policy has no impact on resources outside of owner's responsibility. Further, in another embodiment, in case a local authorization policy is in conflict with other relevant parts of the policy—a conflict-resolution mechanism is used to resolve conflicts.

According to one or more embodiments, an authorization policy may be a grant access policy, a grant access and report policy, a report and recommend policy, or a report policy. A grant access policy is a policy that is defined by an authorization system and policy engine that can provide an access grant in response to an access request from a user when the access request meets a certain set of criteria as defined by a resource owner. An example of a grant access policy in action is shown, for example, in FIG. 3. A grant access and report policy is a policy that operates the same as a grant access policy but adds the additional step of reporting the grant to the resource owner. The criteria is also defined by the resource owner such that, when met by an access request, will trigger the authorization system and policy engine to grant and report.

Further, a repot and recommend policy includes providing the access request to the resource owner along with a recommendation on whether or not the authorization system and system administrator would grant the request access. An example of this report policy is shown in FIG. 2. Further, a report policy includes simply reporting the request received to the resource owner without any recommendation. An example of this report policy can also be represented by FIG. 2. Accordingly, there can be provided a layering of different response policies available that depend on how and to who the resource owner wants to grant access.

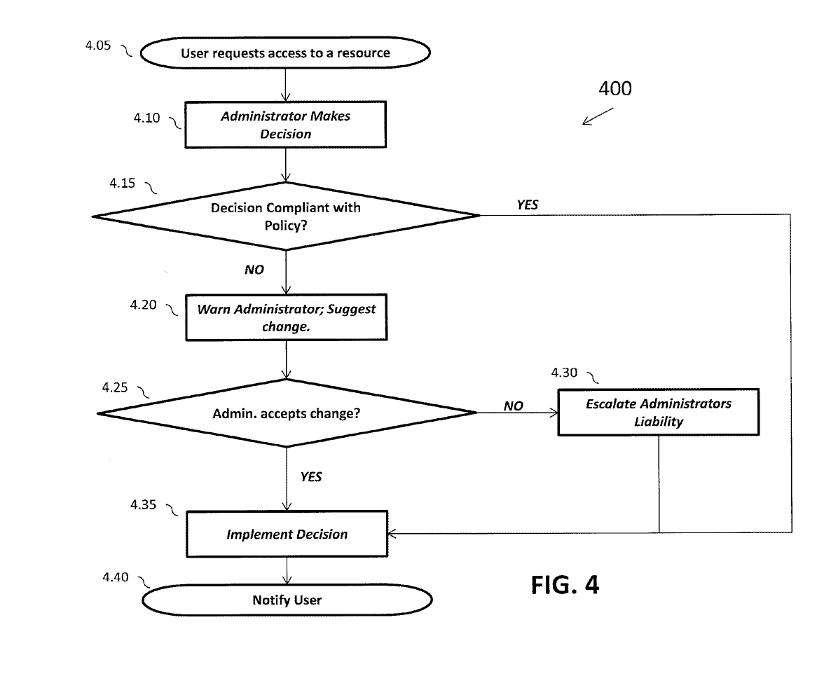

FIG. 4 illustrates a compliance method 400 for checking authorization and resource access decisions with a policy in accordance with one or more exemplary embodiments.

Specifically, a user 310 requests access to a resource (operation 4.05) and the administrator or resource owner 340 makes a decision on that request (operation 4.10). The policy engine 330 then checks if the decision by the resource owner 340 is compliant with the policy or policies set in the policy engine 330 (operation 4.15). If they are not compliant the policy engine 330 warns the administrator 340 and suggests a change in line with the policy (operation 4.20). The policy engine 330 then checks to see if the administrator 340 accepted the change (operation 4.25). If the administrator 340 did not accept the change the policy engine 330 can escalate the administrator's 340 liability (operations 4.30). The decision in then implemented (operation 4.35) and the user 310 is notified of the decision (operation 4.40). Thus, as shown, decisions made by the resource owner 340 are checked for compliance with the policy engine 330. Then, in case of a mismatch the resource owner 340 is either prevented from making a non-compliant decision or is warned and allowed to override the policy-based recommendation, in which case the resource owner 340 takes further responsibility for non-compliant authorization.

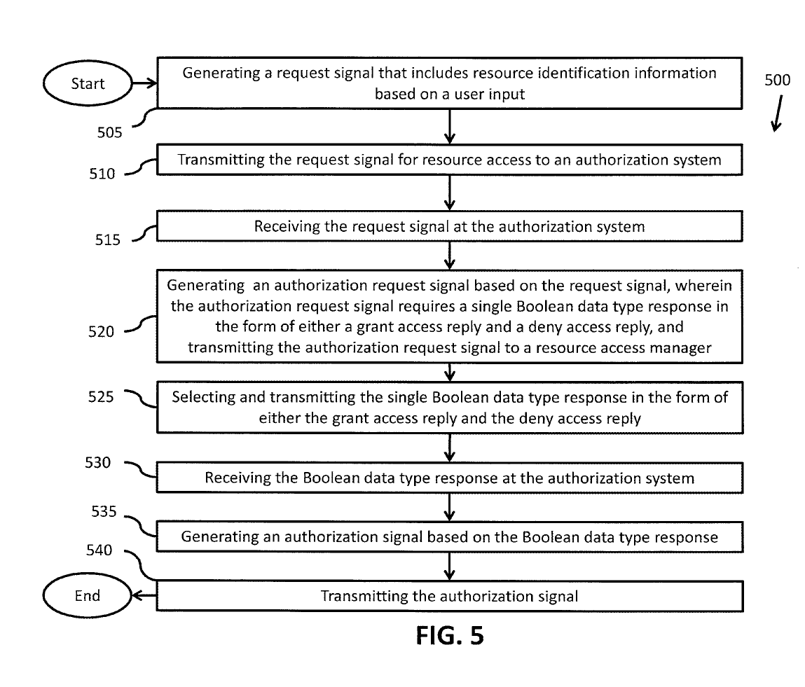

FIG. 5 illustrates a method 500 for controlling authorization decisions for resource access in accordance with one or more exemplary embodiments.

Specifically, the method 500 includes generating, using a processor of a user device, a request signal that includes resource identification information based on a user input (operation 505). The method 500 also includes transmitting, from the user device, the request signal for resource access to an authorization system (operation 510) and receiving the request signal at the authorization system (operation 515). The method 500 further includes generating an authorization request signal based on the request signal, wherein the authorization request signal requires a single Boolean data type response in the form of either a grant access reply and a deny access reply, and transmitting the authorization request signal to a resource access manager (operation 520). The method 500 also includes selecting and transmitting, using the resource access manager, the single Boolean data type response in the form of either the grant access reply and the deny access reply (operation 525). Further, the method 500 includes receiving the Boolean data type response at the authorization system (operation 530), generating an authorization signal based on the Boolean data type response (operation 535), and transmitting the authorization signal to the user device (operation 540). Optionally, in accordance with another embodiment, the authorization signal may include an explanation of a grant or deny decision in addition to the Boolean data type response, which may also be called a Boolean indicator.

According to another embodiment, the resource access manager may include a policy engine that applies authorization logic and authorization policies to automatically process the authorization request signal without explicit manual involvement and generates the Boolean data type response based on the automatically processed authorization request signal. Further, according to another embodiment the resource access manager further includes a resource owner that specifies the authorization policies which are then repeatedly used by the policy engine to make decisions. According to another embodiment, the authorization policies include one or more of a grant access policy, a grant access and report policy, a report and recommend policy, and a report policy. Further, in another embodiment, the method includes overriding, by the resource owner, the automatic processing by the policy engine of the authorization request signal by selecting the Boolean data type response and calculating, using the policy engine, whether the Boolean data type response selected by the resource owner is in compliance with the authorization policies in response to the resource owner overriding.

In another embodiment, the resource access manager includes a resource owner that generated the single Boolean data type response using a 1-click authorization response utilizing one or more communication channels and one or more message communication schemes. In another embodiment the authorization request signal includes a grant link that when selected by the resource owner returns the grant access reply as the Boolean data type response to the authorization system, and a deny link that when selected by the resource owner returns the deny access reply as the Boolean data type response to the authorization system.

In another embodiment, the message communication schemes include email, instant messaging, texting, and a web-based graphical user interface (GUI). Further, in another embodiment the one or more communication channels include a Personal area network (PAN), Local area network (LAN), Metropolitan area network (MAN), Wide area network (WAN), Storage area network (SAN), Enterprise private network (EPN), and Virtual private network (VPN) implemented over a wireless connection, a wired connection, or a combined wired and wireless connection.

Advantageously, embodiments described herein provide a process that allows automation of authorization process based on authorization rules written by individual authorizers. Furthermore, according to one or more embodiments, the authorization workflows disclosed may rely on an ability to learn and use the authorization software system which the 1-click authorization helps streamline by streamlining decision making and reduces the learning curve.

Other benefits that may be provided include significant savings of man-hours that authorizers spend on approving or denying decisions. Also, the significant yearly costs associated with maintaining and operating the electronic authorization process may be reduced. For many organizations in physical access control, the savings could be even greater since many organizations would not have any form of electronic authorization workflow in place and would instead be replacing there previous reliance upon paper-based processes or ad-hoc email exchange.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the embodiments in the form disclosed. Many modifications and variations will be apparent to those of ordinary skill in the art without departing from the scope of the disclosure. The embodiments were chosen and described in order to best explain the principles of the disclosure and the practical application, and to enable others of ordinary skill in the art to understand various embodiments with various modifications as are suited to the particular use contemplated.

The present embodiments may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, Smalltalk, C++, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Accordingly, the present disclosure is not to be seen as limited by the foregoing description, but is only limited by the scope of the appended claims.

What is claimed is:

1. A method for controlling authorization decisions for resource access, the method comprising:
generating, using a processor of a user device, a request signal that includes resource identification information based on a user input;
transmitting, from the user device, the request signal for resource access to an authorization system;
receiving the request signal at the authorization system;
generating an authorization request signal based on the request signal, wherein the authorization request signal requires a single Boolean data type response in the form of either a grant access reply and a deny access reply, transmitting the authorization request signal to a resource access manager;
selecting and transmitting, using the resource access manager, the single Boolean data type response in the form of either the grant access reply and the deny access reply;
receiving the Boolean data type response at the authorization system;
generating an authorization signal based on the Boolean data type response; and
transmitting the authorization signal from the authorization system to at least one from a group consisting of the user device and another user device.

2. The method of claim 1, wherein the resource access manager comprises:
a policy engine that applies authorization logic and authorization policies to automatically process the authorization request signal without explicit manual involvement and generates the Boolean data type response based on the automatically processed authorization request signal.

3. The method of claim 2, wherein the resource access manager further comprises:
a resource owner that specifies the authorization policies which are then repeatedly used by the policy engine to make decisions.

4. The method of claim 2, wherein the authorization policies include one or more of a grant access policy, a grant access and report policy, a report and recommend policy, and a report policy.

5. The method of claim 3, further comprising:
overriding, by the resource owner, the automatic processing by the policy engine of the authorization request signal by selecting the Boolean data type response; and
calculating, using the policy engine, whether the Boolean data type response selected by the resource owner is in compliance with the authorization policies in response to the resource owner overriding.

6. The method of claim 1, wherein the resource access manager comprises:
a resource owner that generated the single Boolean data type response using a 1-click authorization response utilizing one or more communication channels and one or more message communication schemes.

7. The method of claim 6, wherein the authorization request signal comprises:
a grant link that when selected by the resource owner returns the grant access reply as the Boolean data type response to the authorization system; and
a deny link that when selected by the resource owner returns the deny access reply as the Boolean data type response to the authorization system.

8. The method of claim 6, wherein the message communication schemes include email, instant messaging, texting, and a web-based graphical user interface (GUI).

9. The method of claim 6, wherein the one or more communication channels include a Personal area network (PAN), Local area network (LAN), Metropolitan area network (MAN), Wide area network (WAN), Storage area network (SAN), Enterprise private network (EPN), and Virtual private network (VPN) implemented over a wireless connection, a wired connection, or a combined wired and wireless connection.

10. A system for controlling authorization decisions for resource access, the system comprising:
a user device that generates, using a processor, a request signal that includes resource identification information based on a user input, and transmits the request signal for resource access;
an authorization system that receives the request signal and generates an authorization request signal based on the request signal, wherein the authorization request signal requires a single Boolean data type response in the form of either a grant access reply and a deny access reply, and wherein the authorization system transmits the authorization request signal; and
a resource access manager that selects and transmits the single Boolean data type response in the form of either the grant access reply and the deny access reply, wherein the authorization system receives the Boolean data type from the resource access manager, generates an authorization signal based on the Boolean data type response, and transmits the authorization signal from the authorization system to at least one from a group consisting of the user device and another user device.

11. The system of claim 10, wherein the resource access manager comprises:
a policy engine that applies authorization logic and authorization policies to automatically process the authorization request signal without explicit manual involvement and generates the Boolean data type response based on the automatically processed authorization request signal.

12. The system of claim 11, wherein the resource access manager further comprises:
a resource owner that specifies the authorization policies which are then repeatedly used by the policy engine to make decisions.

13. The system of claim 11, wherein the authorization policies include one or more of a grant access policy, a grant access and report policy, a report and recommend policy, and a report policy.

14. The system of claim 12, further comprising:
wherein the resource owner overrides the automatic processing by the policy engine of the authorization request signal by selecting the Boolean data type response; and
wherein the policy engine calculates whether the Boolean data type response selected by the resource owner is in compliance with the authorization policies in response to the resource owner overriding.

15. The system of claim 10, wherein the resource access manager comprises:
a resource owner that generated the single Boolean data type response using a 1-click authorization response utilizing one or more communication channels and one or more message communication schemes.

16. The system of claim 15, wherein the authorization request signal comprises:
a grant link that when selected by the resource owner returns the grant access reply as the Boolean data type response to the authorization system; and
a deny link that when selected by the resource owner returns the deny access reply as the Boolean data type response to the authorization system.

17. The system of claim 15, wherein the message communication schemes include email, instant messaging, texting, and a web-based graphical user interface (GUI).

18. The system of claim 15, wherein the one or more communication channels include a Personal area network (PAN), Local area network (LAN), Metropolitan area network (MAN), Wide area network (WAN), Storage area network (SAN), Enterprise private network (EPN), and Virtual private network (VPN) implemented over a wireless connection, a wired connection, or a combined wired and wireless connection.

19. A computer program product for controlling authorization decisions for resource access, the computer program product comprising a computer readable storage medium having program instructions embodied therewith, the program instructions executable by one or more processors to cause the processors to:
generate, using a user device, a request signal that includes resource identification information based on a user input;
transmit, from the user device, the request signal for resource access to an authorization system;
receive the request signal at the authorization system;
generate an authorization request signal based on the request signal,
wherein the authorization request signal requires a single Boolean data type response in the form of either a grant access reply and a deny access reply, and
transmit the authorization request signal to a resource access manager;
select and transmit, using the resource access manager, the single Boolean data type response in the form of either the grant access reply and the deny access reply;
receive the Boolean data type response at the authorization system;
generate an authorization signal based on the Boolean data type response; and
transmit the authorization signal from the authorization system to at least one from a group consisting of the user device and another user device.

20. The computer program product of claim 19, wherein the resource access manager comprises:
a policy engine that applies authorization logic and authorization policies to automatically process the authorization request signal without explicit manual involvement and generates the Boolean data type response based on the automatically processed authorization request signal; and
a resource owner that specifies the authorization policies which are then repeatedly used by the policy engine to make decisions.
